(19) United States
(12) Patent Application Publication
(10) Pub. No.: US 2012/0175033 A1
(43) Pub. Date: Jul. 12, 2012

(54) Rubber Composition and Tire Using Said Composition

(75) Inventors: David Lavialle, Clermont-Ferrand (FR); Jacques Besson, Chamalieres (FR)

(73) Assignees: Michelin Recherche et Technique S.A., Granges-Paccot (CH); SOCIETE DE TECHNOLOGIE MICHELIN, Clermont-Ferrand (FR)

(21) Appl. No.: 13/262,065

(22) PCT Filed: Mar. 30, 2010
(86) PCT No.: PCT/EP10/54226

§ 371 Date: Mar. 29, 2012

(30) Foreign Application Priority Data
Mar. 31, 2009 (FR) 0952062

(51) Int. Cl. B60C 9/00; B60C 9/02; B60C 15/00; B60C 9/18; C08K 5/098; C08K 3/34

(52) U.S. Cl. 152/526; 524/576; 524/445; 524/447; 524/451; 524/449; 524/399; 523/157

(57) ABSTRACT

A rubber composition based on at least a diene elastomer, a reinforcing filler and a crosslinking system, characterized in that it comprises at least 10 to 150 phr of a platy filler and from 0.01 to 0.3 phr of a metal salt. This composition has good processing and mechanical properties, and also improved oxygen impermeability properties over a wide temperature range, from ambient temperatures when the tire is stationary up to the temperatures of the tire when it is running. According to one preferred embodiment, the rubber composition described above can be used in the tire as a protective elastomer layer in at least one part of the tire.

The present invention relates to rubber compositions intended in particular for the manufacture of a protective elastomer layer having an improved impermeability to air, which may be used in particular for the manufacture of tires.

A tire having a radial carcass reinforcement comprises, in a known manner, a crown surmounted by a tread, two beads intended to be in contact with a mounting rim, two sidewalls joining the beads to the crown. The crown comprises a belt that circumferentially reinforces the tire and that is placed radially between the carcass reinforcement and the tread. This belt consists of several plies (or “layers”) of rubber which may or may not be reinforced with reinforcements such as cords or monofilaments, of the metallic or textile type.

However, it is known that corrosive agents such as water or air, capable of penetrating into the tires, may travel to the belt. The presence of air in the belt risks causing corrosion and accelerating fatigue processes (phenomena known as “corrosion fatigue”), while being detrimental to the adhesion between the reinforcements and the neighbouring rubber composition, finally playing a major role in the longevity of the tire performances.

One of the concerns of tire manufacturers is to increase the service life and in particular to improve the endurance, with respect to oxidizing processes, of the rubber compositions, of the metal or textile reinforcements and of the interfaces between these blends and these reinforcements.

In order to reduce these oxidation phenomena, it is known to limit the amount of oxygen, originating from the inflation air or the outside air, which reaches an oxidation-sensitive region. To limit the migration of oxygen, a person skilled in the art may act in many physical, chemical or physicochemical ways.

One of the solutions consists in placing a protective elastomer layer next to the components of the tire to be protected. Furthermore, the protection may be increased by increasing the thickness of this protective elastomer layer. However, such an increase in the weight leads to an increase in the cost price of the tire, and an increase in the heat build-up of the blends that are used within the tire, when the tire is running.

Other solutions propose to retain the oxygen in the protective elastomer layer by reducing the amount of antioxidant, but this does not make it possible to increase the service life of the carcass reinforcement.

Finally, other solutions recommend using, as indicated in the KIRK-OTHMER ENCYCLOPEDIA, third edition, Wiley, volume 3, page 483 in the “barrier polymers” chapter, a polymer that is less permeable to oxygen by increasing its glass transition temperature, T_{g}, its polarity, its crystallinity, its chain stiffness, its degree of compactness (order, symmetry).

The Applicants have discovered, during their research, a novel composition, based on a diene elastomer, a crosslinking system and a reinforcing filler, and comprising at least a metal salt and a platy filler, which makes it possible to overcome all of the drawbacks of the various solutions mentioned above. Indeed, this composition has processing and mechanical properties that are as good as the compositions of the prior art, and also improved oxygen impermeability properties over a wide temperature range, from ambient temperatures when the tire is stationary, up to the temperatures of the tire when it is running.

Thus, a first subject of the invention relates to a rubber composition based on at least a diene elastomer, a reinforcing filler and a vulcanization system, characterized in that it comprises at least:
to 150 phr of a platy filler; and
from 0.01 to 0.3 phr of a metal salt.

The tires of the invention are particularly intended to be fitted on motor vehicles of the passenger type, SUV (“Sport Utility Vehicles”) type, two-wheel vehicles (especially motorcycles) and aircraft, for instance industrial vehicles chosen from vans, heavy vehicles, i.e. underground trains, buses, heavy road transport vehicles (lorries, towing vehicles, trailers), off-road vehicles such as agricultural or civil-engineering vehicles, and other transport or handling vehicles.

The invention relates to the above tires both in the uncured state (i.e. before curing) and in the cured state (i.e. after crosslinking or vulcanization).

The invention also relates to the use, as an oxygen-barrier layer, in a rubber article, of an elastomer composition, the formulation of which is as defined above.

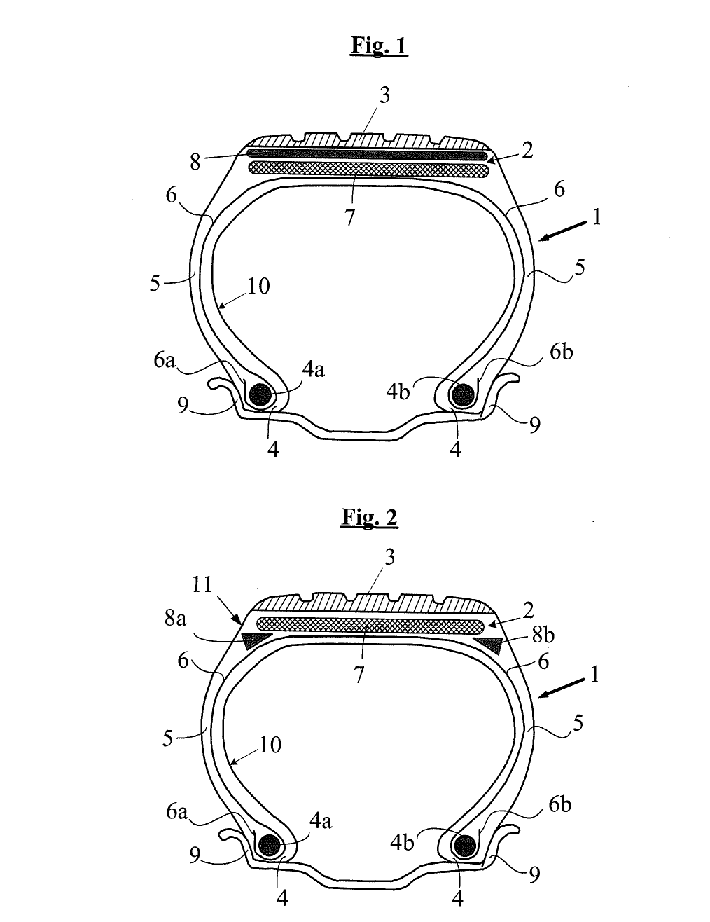

The invention and its advantages will be readily understood in light of the description and exemplary embodiments that follow, and also in light of FIGS. 1 and 2 relating to these examples which schematically show, in radial cross section, two examples of radial tires in accordance with the invention.

### I—MEASUREMENTS AND TESTS USED

The rubber compositions are characterized, before and after curing, as indicated below.

### I-1. Mooney Plasticity

Use is made of an oscillating consistometer as described in French Standard NF T 43-005 (1991). The Mooney plasticity measurement is carried out according to the following principle: the composition in the uncured state (i.e., before curing) is moulded in a cylindrical chamber heated to 100° C. After preheating for one minute, the rotor rotates within the test specimen at 2 revolutions/minute and the working torque for maintaining this movement is measured after rotating for 4 minutes. The Mooney plasticity (ML 1+4) is expressed in “Mooney units” (MU, with 1 MU=0.83 Newton.metre).

### I-2. Rheometry

The measurements are carried out at 150° C. with an oscillating chamber rheometer, according to Standard DIN 53529—part 3 (June 1983). The change in the rheometric torque as a function of time describes the change in the stiffening of the composition as a result of the vulcanization reaction. The measurements are processed according to Standard DIN 53529-part 2 (March 1983): Tᵢ is the induction period, that is to say the time necessary for the start of the vulcanization reaction. Also measured is the 1^{st} order conversion rate constant denoted by K (expressed in min⁻¹), calculated between 30% and 80% conversion, which makes it possible to assess the vulcanization kinetics.

### I-3. Tensile Tests

These tests are carried out in accordance with French Standard NF T 46-002 of September 1988. The “nominal” secant moduli (or apparent stresses, in MPa) are measured in second elongation (i.e., after an accommodation cycle) at 10% elongation (denoted “MA10”) and 100% elongation (“MA100”). All these tensile measurements are carried out under the standard conditions of temperature (23±2° C.) and hygrometry (50±5% relative humidity) according to French Standard NF T 40-101 (December 1979).

### I.4—Permeability at 40° C. and 80° C.

The permeability values are measured using a Mocon Oxtran 2/60 permeability “tester” at 40° C. and 80° C. Cured samples in the form of discs with a predetermined thickness (approximately 0.8 to 1 mm) are fitted to the device and rendered airtight with vacuum grease. One of the faces of the disc is kept under 10 psi (approximately 0.7 bar) of nitrogen while the other face is kept under 10 psi of oxygen. The increase in the concentration of oxygen is monitored using a “Coulox” oxygen detector on the face kept under nitrogen. The concentration of oxygen on the face kept under nitrogen which makes it possible to achieve a constant value, used to determine the oxygen permeability, is recorded. An arbitrary value of 100 is given for the oxygen permeability of the control, a result of less than 100 indicating a reduction in the oxygen permeability and thus a better impermeability.

### II. CONDITIONS FOR IMPLEMENTING THE INVENTION

The rubber composition according to the invention is based on at least a diene elastomer, a reinforcing filler and a crosslinking system, characterized in that it comprises at least:
from 10 to 150 phr of a platy filler; and
from 0.01 to 0.3 phr of a metal salt.

The abbreviation “phr” signifies parts by weight per 100 parts by weight of the elastomer or of all of the elastomers present in the composition.

The expression “composition based on” should be understood as meaning a composition comprising the mixture and/or the reaction product of the various constituents used, some of these base constituents being capable of reacting or intended to react with one another, at least in part, during the various phases of manufacture of the composition, in particular during the crosslinking or vulcanization thereof.

In the present description, unless expressly indicated otherwise, all the percentages (%) shown are percentages (%) expressed by weight. Moreover, any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b).

### II.1—Diene Elastomer

The term “diene” elastomer or rubber should be understood to mean, in a known manner, an (one or more is understood) elastomer resulting at least in part (i.e., a homopolymer or a copolymer) from diene monomers (monomers bearing two carbon-carbon double bonds which may or may not be conjugated).

These diene elastomers can be classified into two categories: “essentially unsaturated” or “essentially saturated”. The term “essentially unsaturated” is understood to mean generally a diene elastomer resulting at least in part from conjugated diene monomers having a content of units of diene origin (conjugated dienes) which is greater than 15% (mol %). Thus it is that diene elastomers, such as butyl rubbers or copolymers of dienes and of α-olefins of EPDM type do not come under the preceding definition and can especially be described as “essentially saturated” diene elastomers (low or very low content of units of diene origin, always less than 15%). In the category of “essentially unsaturated” diene elastomers, the term “highly unsaturated” diene elastomer is understood to mean in particular a diene elastomer having a content of units of diene origin (conjugated dienes) which is greater than 50%.

Given these definitions, the term diene elastomer capable of being used in the compositions in accordance with the invention is understood more particularly to mean:
(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d)—a copolymer of isobutene and of isoprene (butyl rubber) and also the halogenated versions, in particular chlorinated or brominated versions, of this type of copolymer.

Although it applies to any type of diene elastomer, a person skilled in the art of tires will understand that the present invention is preferably employed with essentially unsaturated diene elastomers, in particular of type (a) or (b) above.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyl-toluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or else functionalized with a coupling and/or star-branching or functionalization agent. Mention may be made, for coupling to carbon black, for example, of functional groups comprising a C—Sn bond or aminated functional groups, such as benzophenone, for example; mention may be made, for coupling to a reinforcing inorganic filler, such as silica, of, for example, silanol or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). Mention may also be made, as other examples of functionalized elastomers, of elastomers (such as SBR, BR, NR or IR) of the epoxidized type.

The following are suitable: polybutadienes, in particular those having a content (molar %) of 1,2-units of between 4% and 80% or those having a content (molar %) of cis-1,4-units of greater than 80%, polyisoprenes, butadiene/styrene copolymers and in particular those having a T_{g} (glass transition temperature, T_{g}, measured according to ASTM D3418) of between 0° C. and −70° C. and more particularly between −10° C. and −60° C., a styrene content of between 5% and 60% by weight and more particularly between 20% and 50%, a content (molar %) of 1,2-bonds of the butadiene part of between 4% and 75% and a content (molar %) of trans-1,4-bonds of between 10% and 80%, butadiene/isoprene copolymers, in particular those having an isoprene content of between 5% and 90% by weight and a T_{g} of −40° C. to −80° C., or isoprene/styrene copolymers, in particular those having a styrene content of between 5% and 50% by weight and a T_{g} of between −25° C. and −50° C. In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content (molar %) of 1,2-units of the butadiene part of between 4% and 85%, a content (molar %) of trans-1,4-units of the butadiene part of between 6% and 80%, a content (molar %) of 1,2- plus 3,4-units of the isoprene part of between 5% and 70% and a content (molar %) of trans-1,4-units of the isoprene part of between 10% and 50%, and more generally any butadiene/styrene/isoprene copolymer having a T_{g} of between −20° C. and −70° C., are suitable in particular.

In summary, the diene elastomer of the composition in accordance with the invention is preferably chosen from the group of highly unsaturated diene elastomers consisting of polybutadienes (abbreviated to “BR”), synthetic polyisoprenes (IR), natural rubber (NR), butadiene copolymers, isoprene copolymers and blends of these elastomers. Such copolymers are more preferably chosen from the group consisting of butadiene/styrene copolymers (SBR), isoprene/butadiene copolymers (BIR), isoprene/styrene copolymers (SIR) and isoprene/butadiene/styrene copolymers (SBIR).

According to one particular embodiment, the diene elastomer is predominantly (i.e., for more than 50 phr) an SBR, whether this is an SBR prepared in emulsion (“ESBR”) or an SBR prepared in solution (“SSBR”), or an SBR/BR, SBR/NR (or SBR/IR), BR/NR (or BR/IR) or else SBR/BR/NR (or SBR/BR/IR) blend (mixture). In the case of an SBR (ESBR or SSBR) elastomer, use is made in particular of an SBR having a moderate styrene content, for example of between 20% and 35% by weight, or a high styrene content, for example from 35% to 45%, a content of vinyl bonds of the butadiene part of between 15% and 70%, a content (molar %) of trans-1,4-bonds of between 15% and 75% and a T_{g} of between −10° C. and −55° C.; such an SBR can advantageously be used as a mixture with a BR preferably having more than 90% (molar %) of cis-1,4-bonds.

According to another particular embodiment, the diene elastomer is predominantly (for more than 50 phr) an isoprene elastomer.

The term “isoprene elastomer” is understood to mean, in a known way, an isoprene homopolymer or copolymer, in other words a diene elastomer chosen from the group consisting of natural rubber (NR) which may be plasticized or peptized, synthetic polyisoprenes (IR), the various copolymers of isoprene and the mixtures of these elastomers. Mention will in particular be made, among isoprene copolymers, of isobutene/isoprene copolymers (butyl rubber—IIR), isoprene/styrene copolymers (SIR), isoprene/butadiene copolymers (BIR) or isoprene/butadiene/styrene copolymers (SBIR). This isoprene elastomer is preferably natural rubber or a synthetic cis-1,4-polyisoprene; use is preferably made, among these synthetic polyisoprenes, of polyisoprenes having a content (molar %) of cis-1,4-bonds of greater than 90%, more preferably still of greater than 98%.

The compositions of the invention may contain a single diene elastomer or a mixture of several diene elastomers, the diene elastomer(s) possibly being used in combination with any type of synthetic elastomer other than a diene elastomer, or even with polymers other than elastomers, for example thermoplastic polymers.

According to one particular embodiment of the invention, the rubber composition according to the invention has the secondary feature of comprising a diene elastomer that has a glass transition temperature (T_{g}) above −35° C., referred to hereinbelow as “high T_{g}” elastomer, said temperature being measured (by DSC, according to ASTM D3418-1999) on the elastomer in the dry state (i.e., without extender oil).

According to one particular embodiment of the invention, the rubber composition comprises between 0 and 80 phr, in particular between 30 and 70 phr, of “high T_{g}” elastomer.

In particular, the “high T_{g}” elastomer is a styrene-butadiene copolymer (SBR). Use is preferably made of a high T_{g} SBR having a styrene content of between 5% and 50% by weight and more particularly between 20% and 50%, a content of 1,2-bonds of the butadiene part of between 4% and 65% and a content of trans-1,4-bonds of between 20% and 80%. A person skilled in the art knows how to modify the microstructure of an SBR elastomer in order to adjust the T_{g} thereof.

According to another preferred embodiment, the high T_{g} SBR has a T_{g} preferably of between −35° C. and 0° C., in particular above −30° C., and more preferably of between −30° C. and −5° C.

The high T_{g} SBR is, for example, SBR with a T_{g} of −25° C., which comprises 24% of 1,2-vinyl, 41% of styrene, 50% of trans-1,4-butadiene, 26% of cis-1,4-butadiene.

According to another preferred embodiment, the “high T_{g}” elastomer is an epoxidized natural rubber (abbreviated to “ENR”).

Epoxidized natural rubbers are used for their properties of excellent abrasion resistance, fatigue strength and flexural strength, and are known for being used in particular in tire sidewalls.

They may be obtained by epoxidation of natural rubber, for example via processes based on chlorohydrin or bromohydrin or processes based on hydrogen peroxides, alkyl hydroperoxides or peracids (such as peracetic acid or performic acid).

They are commercially available and are, for example, sold under the name “ENR-25” (degree of epoxidation: 25% per mole, glass transition temperature: −41° C.) by Guthrie Polymer.

The degree of epoxidation of the epoxidized natural rubber is preferably at least 3% (mol %), more preferably at least 5%, for example within a range from 10% to 40%. When the degree of epoxidation is less than 3%, the targeted technical effect (improvement of oxygen barrier effect) runs the risk of being insufficient. Furthermore, the degree of epoxidation is preferably at most 60%, more preferably at most 50%; when the degree of epoxidation exceeds 60%, the molecular weight of the polymer greatly decreases.

### II.2—Metal Salt

The invention relates to a rubber composition that comprises at least from 0.01 to 0.3 phr of a metal salt. This metal salt is preferably selected from the first series, the second series or the third series of the transition metals from the Periodic Table, or from the lanthanides.

The metals may be for example manganese II or III, iron II or III, cobalt II or III, copper I or H, rhodium II, III or IV and ruthenium. The oxidation state of the metal when it is introduced is not necessarily that of the cationic active form.

The metal is preferably manganese, nickel or copper, more preferably cobalt and more preferably still iron.

The counterion for the metal includes, in particular, the chloride, acetate, stearate, palmitate, 2-ethylhexanoate, neodecanoate or naphthenate.

Mention may especially be made of manganese II or III salts and especially manganese (II) carbonate, acetate or acetylacetonate, manganese (III) acetylacetonate, copper (II) salts and especially copper (II) hydroxide, carbonate, stearate, acetate or acetylacetonate, chromium (III) salts and especially chromium acetylacetonate, cobalt salts and especially cobalt neodecanoate, cobalt 2-ethylhexanoate or cobalt acetylacetonate.

Mention may be made, as iron (III) salts of fatty acids in accordance with the invention, of the salts of tridecanoic, myristic, pentadecanoic, palmitic, heptadecanoic, stearic, nonadecanoic, eicosanoic, heneicosanoic, docosanoic and tricosanoic fatty acids.

Preferably, the iron (III) salt is iron (III) acetylacetonate or iron (III) stearate.

The lanthanide is selected from the group formed by lanthanum, cerium, praseodymium, neodymium, samarium, erbium, and mixtures of these rare-earth elements, and more preferably cerium (IV) sulphate.

Molybdenum (IV) sulphide and molybdenum (IV) oxide are also particularly suitable.

### II.3—Reinforcing Filler

Use may be made of any type of reinforcing filler known for its capabilities of reinforcing a rubber composition which can be used for the manufacture of tires, for example an organic filler, such as carbon black, a reinforcing inorganic filler, such as silica, or a blend of these two types of filler, in particular a blend of carbon black and silica.

All carbon blacks, in particular blacks of the HAF, ISAF or SAF type, conventionally used in tires (“tire-grade” blacks) are suitable as carbon blacks. Mention will more particularly be made, among the latter, of the reinforcing carbon blacks of the 100, 200 or 300 series (ASTM grades), such as, for example, the N234, N326 or N330 blacks, or the blacks of higher series (for example, N660, N683 or N772). The carbon blacks might, for example, be already incorporated in an isoprene elastomer in the form of a masterbatch (see, for example, Applications WO 97/36724 or WO 99/16600).

Mention may be made, as examples of organic fillers other than carbon blacks, of the functionalized polyvinylaromatic organic fillers as described in Applications WO-A-2006/069792 and WO-A-2006/069793, or else of the functionalized nonaromatic polyvinyl organic fillers as described in Applications WO-A-2008/003434 and WO-A-2008/003435.

The term “reinforcing inorganic filler” should be understood, in the present patent application, by definition, as meaning any inorganic or mineral filler, whatever its colour and its origin (natural or synthetic), also known as “white filler”, “clear filler” or even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

The physical state in which the reinforcing inorganic filler is provided is not important, whether it is in the form of a powder, of micropearls, of granules, of beads or any other appropriate densified form. Of course, the term reinforcing inorganic filler is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used may be any reinforcing silica known to a person skilled in the art, in particular any precipitated or pyrogenic silica having a BET surface area and a CTAB specific surface area that are both less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165 MP, 1135 MP and 1115 MP silicas from Rhodia, the Hi-Sil EZ150G silica from PPG, the Zeopol 8715, 8745 and 8755 silicas from Huber or the silicas with a high specific surface area as described in Application WO 03/16837.

Preferably, the content of total reinforcing filler (carbon black and/or reinforcing inorganic filler, such as silica) is between 10 and 200 phr, more preferably between 20 and 150 phr, the optimum being, in a known manner, different depending on the particular applications targeted: the level of reinforcement expected with regard to a bicycle tire, for example, is, of course, less than that required with regard to a tire capable of running at high speed in a sustained manner, for example a motorcycle tire, a tire for a passenger vehicle or a tire for a utility vehicle, such as a heavy vehicle.

According to one particular embodiment of the invention, the rubber composition comprises carbon black and silica. In this case, the carbon black content is preferably within a range from 5 to 90 phr, more preferably from 10 to 60 phr, and the silica content is preferably between 5 and 90 phr, more preferably between 10 and 60 phr.

According to one preferred embodiment of the invention, use is made of a reinforcing filler comprising between 30 and 150 phr, more preferably between 50 and 120 phr, of inorganic filler, particularly silica, and optionally carbon black; the carbon black, when it is present, is preferably used at a content of less than 20 phr, more preferably of less than 10 phr (for example between 0.1 and 10 phr).

In order to couple the reinforcing inorganic filler to the diene elastomer, use is made, in a known manner, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use is made in particular of polysulphide-containing silanes, referred to as “symmetrical” or “asymmetrical” depending on their particular structure, as described, for example, in Applications WO 03/002648 (or US 2005/016651) and WO 03/002649 (or US 2005/016650).

Particularly suitable, without the definition below being limiting, are “symmetrical” polysulphide-containing silanes corresponding to the following general formula (I):

Z-A-Sₓ-A-Z, in which: (I)
x is an integer from 2 to 8 (preferably from 2 to 5);
A is a divalent hydrocarbon radical (preferably, C₁-C₁₈ alkylene groups or C₆-C₁₂ arylene groups, more particularly C₁-C₁₀, in particular C₁-C₄, alkylenes, especially propylene);
Z corresponds to one of the formulae below:

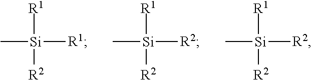

in which:
the R¹ radicals, which are unsubstituted or substituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, in particular C₁-C₄ alkyl groups, more particularly methyl and/or ethyl);
the R² radicals, which are unsubstituted or substituted and identical to or different from one another, represent a C₁-C₁₈ alkoxy or C₅-C₁₈ cycloalkoxy group (preferably a group chosen from C₁-C₈ alkoxys and C₅-C₈ cycloalkoxys, more preferably still a group chosen from C₁-C₄ alkoxys, in particular methoxy and ethoxy).

In the case of a mixture of polysulphide-containing alkoxysilanes corresponding to the above formula (I), in particular the usual mixtures available commercially, the mean value of the “x” index is a fractional number preferably between 2 and 5, more preferably in the vicinity of 4. However, the invention may also advantageously be carried out, for example, with disulphide-containing alkoxysilanes (x=2).

Mention will more particularly be made, as examples of polysulphide-containing silanes, of bis((C₁-C₄)alkoxy(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is in particular made, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂. Mention will also be made, as preferred examples, of bis(mono(C₁-C₄)alkoxydi(C₁-C₄)alkylsilylpropyl) polysulphides (in particular disulphides, trisulphides or tetrasulphides), more particularly bis(monoethoxydimethylsilylpropyl) tetrasulphide, as described in Patent Application WO 02/083782 (or US 2004/132880).

Mention will in particular be made, as coupling agent other than polysulphide-containing alkoxysilane, of bifunctional POSs (polyorganosiloxanes) or else of hydroxysilane polysulphides (R²═OH in the above formula I), such as described in Patent Applications WO 02/30939 (or U.S. Pat. No. 6,774,255) and WO 02/31041 (or US 2004/051210), or else of silanes or POSs bearing azodicarbonyl functional groups, such as described, for example, in Patent Applications WO 2006/125532, WO 2006/125533 and WO 2006/125534.

In the rubber compositions in accordance with the invention, the content of coupling agent is preferably between 2 and 20 phr, more preferably between 4 and 12 phr.

A person skilled in the art will understand that a reinforcing filler of another nature, in particular organic nature, might be used as filler equivalent to the reinforcing inorganic filler described in the present section, provided that this reinforcing filler is covered with an inorganic layer, such as silica, or else comprises, at its surface, functional sites, in particular hydroxyls, requiring the use of a coupling agent in order to form the connection between the filler and the elastomer.

### II.4—Platy Filler

The composition according to the invention has an essential feature of comprising from 10 to 150 phr of a platy filler. This filler may be either an inert filler or a reinforcing or semi-reinforcing filler, all fillers capable of reducing the characteristics of permeability of gases through a protective elastomer element, starting from the composition.

Fillers referred to as platy fillers are well known to a person skilled in the art. They have especially been used in pneumatic tires for reducing the permeability of conventional gastight layers (“inner liners”) based on butyl rubber. In these layers based on butyl rubber, they are generally used at relatively low levels, which do not usually exceed 10 to 25 phr (see, for example, patent documents US 2004/0194863, WO 2006/047509).

They are generally in the form of stacked plates, platelets, sheets or foils with a relatively pronounced anisometry of these particles.

These fillers are characterized by their aspect ratio (F=L/E), L representing the median length (or larger dimension) and E the median thickness of these platy fillers, these averages being calculated by number. Preferably, this aspect ratio is between 1 and 1000, especially between 1 and 500.

These platy fillers are preferably of micrometer size, that is to say that they are in the form of microparticles, the size or median length (L) of which is greater than 0.05 μm. According to one preferred embodiment, the median length (L) of the particles is between 0.05 and 500 μm, more preferably between 0.2 and 250 μm. According to another preferred embodiment, the median thickness (E) of the particles is itself between 10 and 500 nm, preferably between 50 and 250 nm.

The platy filler is present in the composition in accordance with the invention in contents within a range from 10 phr to 150 phr, in particular from 20 to 100 phr, preferably from 15 to 80 and more preferably still from 15 to 50 phr.

Below the above minimum values, both for the content and for the size of the particles, the targeted technical effect is not obtained; the permeability of the protective elastomer layer is not sufficiently reduced. Above the recommended maximum values, both for the content and for the size of the particles, there is a risk of deteriorating the mechanical properties of the composition.

Preferably, the platy fillers used in accordance with the invention are chosen from the group consisting of graphites, phyllosilicates and mixtures of such fillers. Among the phyllosilicates, mention will especially be made of clays, talcs, micas, kaolins, these phyllosilicates possibly being modified or not for example by a surface treatment; as examples of such modified phyllosilicates, mention may especially be made of micas covered with titanium oxide, and clays modified by surfactants (“organoclays”).

Use is preferably made of platy fillers having a low surface energy, that is to say that are relatively apolar, such as those chosen from the group composed of graphites, talcs, micas and mixtures of such fillers, the latter possibly being modified or not, more preferably still from the group formed by graphites, talcs and mixtures of such fillers. Among the graphites use may be made of natural graphites and synthetic graphites.

By way of example, the compositions of the invention may contain a single graphite or a mixture of several graphites.

Graphites are commercially available, especially sold by Imerys under the names:
“TIMREX GA 95/75” with a D₅₀ of 20 μm; and
“TIMREX GB 99/6” with a D₅₀ of 3 μm.

As examples of talcs, mention may be made of the talcs sold by Luzenac.

As examples of micas, mention may be made of the micas sold by CMMP (Mica-MU®, Mica-Soft®, Briomica® for example), vermiculites (especially the Shawatec® vermiculite sold by CMMP or the Microlite® vermiculite sold by W.R. Grace), modified or treated micas (for example, the Iriodin® range sold by Merck).

According to another particular embodiment of the invention, use is made, as platy fillers, of non-reinforcing fillers and more particularly silicon-based platy mineral fillers are suitable here.

In particular, among the silicon-based platy mineral fillers, phyllosilicates, and particularly those included in the group consisting of smectites, kaolin, talc, mica, vermiculite and montmorillonites, are suitable.

Among the phyllosilicates, functionalized phyllosilicates and in particular organomodified phyllosilicates are also suitable for the invention. According to a specific embodiment, the organic structure with which the inert filler is combined is a surfactant of formula: -M⁺R¹R²R³—,
where M represents a nitrogen, sulphur or phosphorus atom or pyridine and where R¹,
R² and R³ represent a hydrogen atom, an alkyl group, an aryl group or an allyl group, R¹, R² and R³ being identical or different.

In particular, phyllosilicates of the organomodified montmorillonite type are suitable for the invention, thus montmorillonites modified with a surfactant, such as a dihydrogenated dioctadecyldimethyl quaternary ammonium salt.

Such an organomodified montmorillonite is sold in particular by Southern Clay Products under the trade name: Cloisite 20A, having a density of 2.6 and the particle diameter of which is between 0.2 and 0.5 μm.

Other surfactants based on quaternary ammonium salts can also be used to modify phyllosilicates, such as described in Patent Application WO 2006/047509.

According to another embodiment of the invention, the platy fillers are kaolin particles described previously, commercially available and sold by Imerys under the name Kerbrient SP20.

The platy fillers may be introduced into the elastomer composition according to various known processes, for example by compounding in solution, by bulk compounding in an internal mixer, or else by compounding via extrusion.

For the particle size analysis and the calculation of the median size of the (micro)particles of platy filler, various known methods can be applied, for example via laser scattering (see, for example, ISO-8130-13 standard or JIS K5600-9-3 standard).

It is also possible to use, simply and preferably, a particle size analysis via mechanical screening; the operation consists in screening a defined amount of sample (for example, 200 g) on a vibrating table for 30 min with different screen diameters (for example, according to an increasing ratio, with meshes of 75, 105, 150, 180, etc.); the oversize material collected on each screen is weighed on a precision balance; the % of oversize material for each mesh diameter relative to the total weight of product is deduced therefrom; the median size (or median diameter) is finally calculated in a known manner from the histogram of the particle size distribution.

### II.5—Various Additives

The rubber compositions in accordance with the invention also comprise all or some of the usual additives customarily used in elastomer compositions intended for the manufacture of tires, such as, for example, pigments, protective agents such as anti-ozone waxes, chemical antiozonants, antioxidants, plasticizing agents, anti-fatigue agents, reinforcing resins, methylene acceptors (for example, phenol-novolac resin) or methylene donors (for example, HMT or H3M), a crosslinking system based either on sulphur or on sulphur donors and/or on peroxide and/or on bismaleimides, vulcanization accelerators and vulcanization activators.

The rubber compositions of the invention preferably use a hydrocarbon-based plasticizing resin having a high glass transition temperature (T_{g}), the T_{g} of which is above 20° C.

In a manner known to a person skilled in the art, the name “plasticizing resin” is reserved in the present patent application, by definition, for a compound which is, on the one hand, solid at ambient temperature (23° C.) (in contrast to a liquid plasticizing compound, such as an oil) and, on the other hand, compatible (that is to say, miscible at the level used) with the rubber composition for which it is intended, so as to act as a true diluent.

The content of hydrocarbon-based plasticizing resin is preferably within a range from 1 to 20 phr. Below the indicated minimum, the targeted technical effect may prove insufficient, whereas above 20 phr there is a risk of increasing the tack of the compositions in the uncured state, with respect to the compounding tools, which may, in certain cases, become unacceptable from an industrial viewpoint.

Preferably, the hydrocarbon-based plasticizing resin exhibits at least one, more preferably all, of the following characteristics:
a number-average molecular weight (Mₙ) of between 400 and 2000 g/mol;
a polydispersity index (Iₚ) of less than 2 (reminder: Iₚ=M_{w}/Mₙ with M_{w} being the weight-average molecular weight).

The glass transition temperature T_{g} is measured in a known manner by DSC (Differential Scanning calorimetry), according to the standard ASTM D3418 (1999), and the softening point is measured according to the standard ASTM E-28.

The macrostructure (M_{w}, Mₙ and Iₚ) of the hydrocarbon-based plasticizing resin is determined by size exclusion chromatography (SEC): solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 “Waters” columns in series (“Styragel” HR4E, HR1 and HR0.5); detection by differential refractometer (“Waters 2410”) and its associated operating software (“Waters Empower”).

The above resins may be aliphatic, naphthenic, aromatic or else of aliphatic/aromatic type, that is to say based on aliphatic and/or aromatic monomers. They may be natural or synthetic and may or may not be petroleum-based (if such is the case, also known under the name of petroleum resins). They are preferably exclusively hydrocarbon-based, that is to say that they comprise only carbon and hydrogen atoms.

According to one particularly preferred embodiment, the hydrocarbon-based plasticizing resin is chosen from the group formed by cyclopentadiene (abbreviated to CPD) or dicyclopentadiene (abbreviated to DCPD) homopolymer or copolymer resins, terpene homopolymer or copolymer resins, C₅ fraction homopolymer or copolymer resins and the mixtures of these resins.

Mention will especially be made, among the above hydrocarbon-based plasticizing resins, of the resins of homopolymers or copolymers of α-pinene, β-pinene, dipentene or polylimonene, C₅ fraction, for example of C₅ fraction/styrene copolymer or C₅ fraction/C₉ fraction copolymer, which can be used alone or in combination with plasticizing oils such as, for example, MES or TDAE oils.

These compositions may, in addition to coupling agents, also contain coupling activators, agents for covering the inorganic fillers, or more generally processing aids capable, in a known manner, owing to an improvement in the dispersion of the filler in the rubber matrix and to a lowering in the viscosity of the compositions, of improving their ability to be processed in the uncured state, these agents being, for example, hydrolysable silanes such as alkylalkoxysilanes, polyols, polyethers, primary, secondary or tertiary amines or hydroxylated or hydrolysable polyorganosiloxanes.

### II.6—Preparation of the Rubber Compositions

The compositions are manufactured in appropriate mixers using two successive preparation phases well known to a person skilled in the art: a first phase of thermomechanical working or kneading (referred to as a “non-productive” phase) at high temperature, up to a maximum temperature of between 110° C. and 190° C., preferably between 130° C. and 180° C., followed by a second phase of mechanical working (referred to as a “productive” phase) up to a lower temperature, typically below 110° C., for example between 40° C. and 100° C., finishing phase during which the crosslinking system is incorporated.

The process in accordance with the invention for preparing a rubber composition comprises the following stages:
incorporating into a diene elastomer, during a first stage (referred to as a “non-productive” stage), at least a reinforcing filler, a platy filler and a metal salt, everything being kneaded thermomechanically (for example in one or more steps), until a maximum temperature of between 110° C. and 190° C. is reached;
cooling the combined mixture to a temperature below 100° C.;
subsequently incorporating, during a second stage (referred to as a “productive” stage), a crosslinking system;
kneading everything up to a maximum temperature below 110° C.

By way of example, the non-productive phase is carried out in a single thermomechanical stage during which, in a first step, all the necessary base constituents (the diene elastomer, the reinforcing filler, from 10 to 150 phr of the platy filler and from 0.01 to 0.3 phr of metal salt) are introduced into an appropriate mixer, such as a standard internal mixer, followed, in a second step, for example after kneading for one to two minutes, by the other additives, optional additional filler-covering agents or processing aids, with the exception of the crosslinking system. The total kneading time, in this non-productive phase, is preferably between 1 and 15 min.

After cooling the mixture thus obtained, the crosslinking system is then incorporated in an external mixer, such as an open mill, maintained at a low temperature (for example, between 40° C. and 100° C.). The combined mixture is then mixed (productive phase) for a few minutes, for example between 2 and 15 min.

The crosslinking system itself is preferably based on sulphur and on a primary vulcanization accelerator, in particular an accelerator of the sulphenamide type. Added to this vulcanization system are various known secondary accelerators or vulcanization activators, such as zinc oxide, stearic acid, guanidine derivatives (in particular diphenylguanidine), etc., incorporated during the first non-productive phase and/or during the productive phase. The sulphur content is preferably between 0.5 and 10 phr, more preferably between 1.5 and 8, and the primary accelerator content is preferably between 0.5 and 5.0 phr.

Use may be made, as (primary or secondary) accelerator, of any compound capable of acting as accelerator of the vulcanization of diene elastomers in the presence of sulphur, in particular accelerators of the thiazole type and also their derivatives, accelerators of the thiuram and zinc dithiocarbamate types. These accelerators are more preferably chosen from the group formed by 2-mercaptobenzothiazyl disulphide (abbreviated to “MBTS”), N-cyclohexyl-2-benzothiazyl sulphenamide (abbreviated to “CBS”), N,N-dicyclohexyl-benzothiazyl sulphenamide (abbreviated to “DCBS”), N-tert-butyl-2-benzothiazyl sulphenamide (abbreviated to “TBBS”), N-tert-butyl-2-benzothiazyl sulphenimide (abbreviated to “TBSI”), zinc dibenzyldithiocarbamate (abbreviated to “ZBEC”) and mixtures of these compounds. Preferably, a primary accelerator of the sulphenamide type is used.

The final composition thus obtained may then be calendered, for example in the form of a sheet or a slab, in particular for laboratory characterization, or else extruded, for example to form a rubber profiled element intended to be used as a protective elastomer layer of a tire.

### II.7—Tire of the Invention

### II.7.a—Definitions

In the present application, the following definitions are adopted:
“axial”: a direction parallel to the axis of rotation of the tire; this direction may be oriented “axially interior” when it is oriented towards the internal cavity of the tire and “axially exterior” when it is oriented towards the outside of the tire;
“radial plane”: plane containing the axis of rotation of the tire;
“bead”: the portion of the tire internally radially adjacent to each sidewall and this portion being intended to be in contact with a mounting rim;
“sidewall”: the portion of the tire connecting each bead to the crown;
“radial direction”: a direction that bisects the axis of rotation of the tire and is perpendicular to the latter; this direction may be oriented “radially interior” or “radially exterior” depending on whether it is oriented towards the axis of rotation of the tire or towards the outside of said axis;
“reinforcement” or “reinforcing element”: both of monofilaments and of multifilaments, or of assemblies such as cords, folded yarns or else any type of equivalent assembly, irrespective of the material and the treatment of these reinforcements, for example surface treatment or coating such as rubber coating, or else presizing to promote adhesion to the rubber;
“radially oriented reinforcement” or “radial reinforcement”: a reinforcement contained substantially within one and the same radial plane or in a plane that makes, with a radial plane, an angle of less than or equal to 10 degrees.

### II.7.b—Protective Layer

According to a preferred embodiment of the invention, the rubber composition described previously may be used in the tire as a protective layer in at least one part of the tire.

The term rubber protective “layer” is understood to mean any three-dimensional element, of rubber (or “elastomer”, the two being considered to be synonymous) composition, of any shape and thickness, especially sheet, strip, or other element of any, for example rectangular or triangular, cross section.

Firstly, the protective elastomer layer may be used as a sublayer placed in the crown of the tire, between, on the one hand, the tread, i.e., the portion intended to come into contact with the road when running and, on the other hand, the belt that reinforces said crown. The thickness of this protective elastomer layer is preferably within a range that extends from 0.5 to 10 mm, in particular in a range from 1 to 3 mm.

According to another preferred embodiment of the invention, the composition according to the invention may be used to form an annular, protective elastomer layer, placed in the region of the shoulder of the tire, radially between the carcass reinforcement and the crown reinforcement.

Another preferred embodiment of the invention may be the use of the composition according to the invention to form a protective elastomer layer placed against the carcass ply.

Appended FIGS. 1 and 2 represent, in radial cross section, very schematically (in particular not to a specific scale), two preferred examples of tires with radial carcass reinforcement, in accordance with the invention.

In this FIG. 1, the tire 1 shown schematically comprises a crown 2 surmounted by a tread 3, two inextensible beads 4 in which a carcass reinforcement 6 is anchored. The crown 2, joined to said beads 4 by two sidewalls 5, is, in a manner known per se, reinforced by a crown reinforcement or “belt” 7 which is at least partly metallic and radially external with respect to the carcass reinforcement 6, formed from two superposed plies, each of these plies being reinforced by metal cords that are parallel to one another in each ply and that are crossed from one ply to the next.

The carcass reinforcement 6 is here anchored into each bead 4 by winding around a bead wire 4a, 4b in order to form a turn-up 6a, 6b in each bead. The tire 1 is shown here mounted on its rim 9. The carcass reinforcement 6 is formed from at least one ply reinforced by radial textile cords, that is to say these cords are placed practically parallel to one another and extend from one bead to the other so as to form an angle of between 80° and 90° with the median circumferential plane (plane perpendicular to the axis of rotation of the tire which is located half way between the two beads 4 and passes through the middle of the crown reinforcement 7. Of course, this tire 1 additionally comprises, in a known manner, an inner liner layer (commonly referred to as “inner liner”) 10 that defines the radially inner face of the tire and that is intended to protect the carcass ply from the diffusion of air coming from the cavity inside the tire.

FIG. 1 illustrates one possible embodiment of the invention, according to which the protective elastomer layer 8 is placed underneath the tread (i.e., radially interior relative to the latter) and on top of the belt (i.e., radially exterior relative to the latter), in other words between the tread 3 and the belt 7.

According to another preferred embodiment of the invention, illustrated for example in FIG. 2, at least one annular, protective elastomer layer 8a, 8b is placed in the region of the shoulder 11 of the tire, radially between the carcass reinforcement 6 and the exterior parts of the crown reinforcement 7.

According to another embodiment of the invention, a protective elastomer layer may be placed against the carcass reinforcement 6, in particular between the inner liner 10 and the carcass reinforcement 6, or optionally in the region external to the carcass reinforcement 6.

In summary, the protective elastomer layer is preferably placed in at least one area of the tire located:
between the tread (3) and the belt (7), or
between the belt (7) and the carcass reinforcement (6), or
against the carcass reinforcement.

Owing to its improved oxygen-barrier properties, this protective elastomer layer gives the tires of the invention effective protection against the undesired effects of the oxygen from the air that may penetrate through their tread and their sidewalls, and diffuse towards their belt and their carcass ply, as is demonstrated in the rubber tests below.

### III—EXEMPLARY EMBODIMENTS OF THE INVENTION

### III.1—Preparation of the Compositions

The tests which follow are carried out in the following manner: the diene elastomer, the reinforcing filler (silica and/or carbon black), the coupling agent in the presence of silica, from 10 to 150 phr of the platy filler and from 0.01 to 0.3 phr of metal salt and also the various other ingredients, with the exception of the vulcanization system, are successively introduced into an internal mixer (final fill ratio: around 70% by volume), the initial vessel temperature of which is around 60° C. Thermomechanical working (non-productive phase) is then carried out in one stage, which lasts in total approximately 3 to 4 minutes, until a maximum “dropping” temperature of 165° C. is reached.

The mixture thus obtained is recovered and cooled and then sulphur and an accelerator of sulphenamide type are incorporated in a mixer (homofinisher) at 30° C., the combined mixture being mixed (productive phase) for an appropriate time (for example, between 5 and 12 min).

The compositions thus obtained are subsequently calendered, either in the form of slabs (thickness of 2 to 3 mm) or of fine sheets of rubber, for the measurement of their physical or mechanical properties, or extruded in the form of a layer in order to make tires.

### III.2—Tests

### Example 1

### Rubber Compositions with a Platy Filler and a Metal Salt

The object of this test is to show the improvement in the oxygen impermeability performance of three compositions of a tire protective elastomer layer in accordance with the invention, in comparison with a control composition.

For this, four rubber compositions were prepared, as indicated previously, three in accordance with the invention (denoted hereinbelow by C1.2, C1.3 and C1.4) and a control composition comprising only iron acetylacetonate but no platy filler (denoted hereinbelow by C1.1).

The four compositions comprise a natural rubber and iron acetylacetonate. The compositions according to the invention also comprise a platy filler; either graphite for which the particle diameter is of the order of 20 μm (composition C1.2), or graphite for which the particle diameter is around 3 μm (composition C1.3), or kaolin (composition C1.4), and a high T_{g}, hydrocarbon-based plasticizing resin for compositions C1.2 and C1.3.

The compositions according to the invention with or without plasticizing resin exhibit, in the uncured state, a better processability (lower Mooney viscosity) than the control composition C1.1.

The rheological properties of compositions C1.2 to C1.4 are not significantly modified with respect to the control composition C1.1.

After curing, it is observed that the MA10 moduli of compositions C1.2, C1.3 and C1.4 according to the invention are on the whole equivalent to those of the control composition C1.1.

Finally, and above all, it is noted that compositions C1.2, C1.3 and C1.4 in accordance with the invention, comprising a metal salt and, as platy filler, respectively graphite and kaolin, exhibit a much lower permeability than that of the control composition C1.1. Moreover, this reduction in the permeability of the mixtures is more substantial for compositions C1.2 and C1.3, which also comprise a high T_{g}, hydrocarbon-based plasticizing resin.

### Example 2

### Rubber Compositions with a Platy Filler, a Metal Salt and a “High T_{g}” Elastomer

The object of this test is to show the improvement in the oxygen impermeability performance of three compositions of a tire protective elastomer layer in accordance with the invention, in comparison with a control composition.

For this, six rubber compositions were prepared, as indicated previously, five in accordance with the invention (denoted hereinbelow by C2.2, C2.3, C2.4, C2.5 and C2.6) and a control composition (denoted hereinbelow by C2.1). The compositions in accordance with the invention additionally comprise, relative to compositions C1.2 to C1.4, a “high T_{g}” diene elastomer, which is a styrene-butadiene copolymer for compositions C2.3 to C2.6, and an epoxidized natural rubber for composition C2.2.

The compositions according to the invention exhibit, in the uncured state, a better processability (lower Mooney viscosity) than the control composition C2.1. The rheological properties of compositions C2.4 to C2.6 are not significantly affected relative to the control composition C2.1. The rheological properties of compositions C2.2 and C2.3 enable the use thereof in tires.

After curing, it is observed that the MA10 moduli of compositions C2.2 to C2.6 according to the invention are on the whole equivalent to that of the control composition C2.1.

Above all, compositions C2.2 to C2.6 in accordance with the invention, comprising a metal salt, a platy filler and a high T_{g} elastomer, exhibit a much lower permeability than that of the control composition C2.1 and also than compositions C1.2 to C1.4.

However, this reduction in the permeability of the compositions is more substantial for compositions C2.2 and C2.3 which comprise a platy filler of montmorillonite type.

TABLE 1

Composition No.

| | C1.1 | C1.2 | C1.3 | C1.4 |
|---|---|---|---|---|
| NR (1) | 100 | 100 | 100 | 100 |
| Carbon black (2) | 60 | 40 | 40 | 40 |
| Fe(ACAC)₃ (3) | 0.13 | 0.13 | 0.13 | 0.13 |
| Graphite 1 (4) | — | 20 | — | — |
| Graphite 2 (5) | — | — | 20 | — |
| Kaolin (6) | | | — | 30 |
| Resin (7) | — | 10 | 10 | — |
| Stearic acid (8) | 0.6 | 0.6 | 0.6 | 0.6 |
| ZnO (9) | 5 | 5 | 5 | 5 |
| Sulphur (10) | 4.5 | 4.5 | 4.5 | 4.5 |
| Accelerator (11) | 0.9 | 0.9 | 0.9 | 0.9 |
| Antioxidant (12) | 2 | 2 | 2 | 2 |

(1) Natural rubber;
(2) Carbon black: N683;
(3) Iron acetylacetonate: Fe(Acac)₃ from CPAS;
(4) Graphite 1: “TIMREX GB 99/6” natural graphite from Imerys;
(5) Graphite 2: “TIMREX GA 95/75” natural graphite from Imerys;
(6) Natural kaolin “Kerbrient SP20” from Imerys;
(7) C5 fraction hydrocarbon-based resin “Hikorez A1100” from Kolon;
(8) Stearine: “Pristerene” from Uniquema;
(9) Zinc oxide (industrial grade - Umicore);
(10) Sulphur;
(11) N-cyclohexyl-2-benzothiazyl sulphenamide (Santocure CBS from Flexsys);
(12) N-1,3-dimethylbutyl-N-phenyl-para-phenylenediamine (Santoflex 6-PPD from Flexsys).

TABLE 2

Composition No.

| | C1.1 | C1.2 | C1.3 | C1.4 |
|---|---|---|---|---|
| Property before curing | | | | |
| Mooney | 96 | 59 | 53 | 80 |
| Rheometry | | | | |
| Ti (min) | 1.8 | 3 | 3 | 2.7 |
| K (min⁻¹) | 0.52 | 0.49 | 0.57 | 0.58 |

TABLE 3

Composition No.

| | C1.1 | C1.2 | C1.3 | C1.4 |
|---|---|---|---|---|
| MA10 (MPa) | 5.7 | 5.3 | 5.3 | 5.7 |
| MA100 (MPa) | 4 | 3.8 | 2.9 | 3.5 |
| O₂ permeability at 40° C. (%) | 100 | 59 | 60 | 79 |
| O₂ permeability at 80° C. (%) | 100 | 64 | 65 | 80 |

TABLE 4

| | Composition No. | | | | | |
|---|---|---|---|---|---|---|
| | C2.1 | C2.2 | C2.3 | C2.4 | C2.5 | C2.6 |
| NR (1) | 100 | 50 | 50 | 50 | 50 | 50 |
| Carbon black (2) | 60 | 40 | 40 | 40 | 40 | 40 |
| ENR 25 (3) | — | 50 | — | — | — | — |
| SBR (4) | — | — | 50 | 50 | 50 | 50 |
| Fe(ACAC)₃ (5) | 0.13 | 0.13 | 0.13 | 0.13 | 0.13 | 0.13 |
| Montmorillonite (6) | — | 20 | 20 | — | — | — |
| Graphite 1 (7) | — | — | — | 20 | — | — |
| Graphite (8) | — | — | — | — | 20 | — |
| Kaolin (9) | — | — | — | — | — | 30 |
| Resin (10) | — | 10 | 10 | 10 | 10 | 5 |
| Stearic acid (11) | 0.6 | 0.6 | 0.6 | 0.6 | 0.6 | 0.6 |
| ZnO (12) | 5 | 5 | 5 | 5 | 5 | 5 |
| Sulphur (13) | 4.5 | 4.5 | 4.5 | 4.5 | 4.5 | 4.5 |
| Accelerator (14) | 0.9 | 0.9 | 0.9 | 0.9 | 0.9 | 0.9 |
| Antioxidant (15) | 2 | 2 | 2 | 2 | 2 | 2 |

(1) Natural rubber;
(2) Carbon black: N683;
(3) Epoxidized natural rubber: “ENR-25” (Guthrie Polymer);
(4) SBR copolymer solution; 24% of 1,2-vinyl, 41% of styrene, 50% of trans-1,4-butadiene, 26% of cis-1,4-butadiene; (T_{g} = −25° C.);
(5) Iron acetylacetonate: Fe(Acac)₃ from CPAS;
(6) Montmorillonite: “Cloisite 20A” from Southern Clay;
(7) Graphite 1: “TIMREX GB 99/6” from Imerys;
(8) Graphite 2: “TIMREX GA 95/75” natural graphite from Imerys;
(9) Natural kaolin “Kerbrient SP20” from Imerys;
(10) C5 fraction hydrocarbon-based resin “Hikorez A1100” from Kolon;
(11) Stearine: “Pristerene” from Uniquema;
(12) Zinc oxide (industrial grade - Umicore);
(13) Sulphur;
(14) N-cyclohexyl-2-benzothiazyl sulphenamide (Santocure CBS from Flexsys);
(15) N-1,3-dimethylbutyl-N-phenyl-para-phenylenediamine (Santoflex 6-PPD from Flexsys).

TABLE 5

| | Composition No. | | | | | |
|---|---|---|---|---|---|---|
| | C2.1 | C2.2 | C2.3 | C2.4 | C2.5 | C2.6 |
| Property before curing | | | | | | |
| Mooney | 98 | 45 | 43 | 56 | 51 | 84 |
| Rheometry | | | | | | |
| Ti (min) | 2 | 0.5 | 0.8 | 2.4 | 3.8 | 3.4 |
| K (min⁻¹) | 0.48 | 0.7 | 0.25 | 0.41 | 0.44 | 0.31 |

TABLE 6

| | Composition No. | | | | | |
|---|---|---|---|---|---|---|
| | C2.1 | C2.2 | C2.3 | C2.4 | C2.5 | C2.6 |
| MA10 (MPa) | 6.3 | 7.1 | 8 | 6.1 | 6 | 6.8 |
| MA100 (MPa) | 4.5 | 2.5 | 2.8 | 4.5 | 3.5 | 4.5 |
| O₂ permeability at 40° C. (%) | 100 | 28 | 30 | 37 | 34 | 41 |
| O₂ permeability at 80° C. (%) | 100 | 32 | 36 | 45 | 41 | 47 |

1. A rubber composition based on at least a diene elastomer, a reinforcing filler and a crosslinking system, comprising:
10 to 150 phr of a platy filler; and
from 0.01 to 0.3 phr of a metal salt.

2. The rubber composition according to claim 1, wherein the diene elastomer is chosen within the group consisting of polybutadienes, natural rubber, synthetic polyisoprenes, butadiene copolymers, isoprene copolymers and blends of these elastomers.

3. The rubber composition according to claim 1, wherein the content of platy filler is within a range from 20 to 100 phr.

4. The rubber composition according to claim 1, wherein the platy filler is chosen within the group consisting of graphites, phyllosilicates and mixtures of such fillers.

5. The rubber composition according to claim 4, wherein the platy filler comprises graphite particles.

6. The rubber composition according to claim 4, the platy filler comprises phyllosilicate particles.

7. The rubber composition according to claim 6, wherein the platy filler comprises phyllosilicate particles chosen within the group consisting of smectites, kaolin, talc, mica, vermiculite, montmorillonites and mixtures of such phyllosilicates.

8. The rubber composition according to claim 7, wherein the platy filler comprises montmorillonite particles that are organomodified with a surfactant.

9. The rubber composition according to claim 1, wherein the metal salt is chosen within the group consisting of the first series, the second series and the third series of transition metals, the lanthanides and mixtures of such salts.

10. The rubber composition according to claim 9, wherein the metal salt is an iron salt.

11. The rubber composition according to claim 10, wherein the iron salt is iron acetylacetonate.

12. The rubber composition according to claim 1, further comprising a hydrocarbon-based plasticizing resin, the T_{g} of which is above 20° C.

13. The rubber composition according to claim 12, wherein the content of hydrocarbon-based plasticizing resin is within a range from 1 to 20 phr.

14. The rubber composition according to claim 1, wherein the reinforcing filler comprises carbon black and/or silica.

15. The rubber composition according to claim 1, wherein the amount of reinforcing filler is within a range from 10 to 200 phr.

16. The rubber composition according to claim 1, further comprising a “high T_{g}” elastomer, the glass transition temperature (T_{g}) of which is above −35° C.

17. The rubber composition according to claim 16, wherein the “high T_{g}” elastomer is chosen within the group consisting of SBR, and epoxidized natural rubber and blends of these elastomers.

18. The rubber composition according to claim 16, wherein the content of “high T_{g}” elastomer is within a range from 0 to 80 phr.

19-20. (canceled)

21. A tire comprising a rubber composition according to claim 1.

22. A radial tire for motor vehicle, comprising a crown surmounted by a tread, two inextensible beads, two sidewalls connecting the beads to the tread, a carcass reinforcement passing into the two sidewalls and anchored in the beads, said crown being reinforced by a crown reinforcement or belt placed between the carcass reinforcement and the tread, wherein at least one protective elastomer layer, comprising a composition according to claim 1, is placed in at least one area of the tire located:
between the tread and the belt, or
between the belt and the carcass reinforcement, or
against the carcass reinforcement.
